(19) United States
(12) Patent Application Publication
(10) Pub. No.: US 2017/0232932 A1
(43) Pub. Date: Aug. 17, 2017

(54) VEHICLE CONTROL SYSTEM

(71) Applicants: Tetsuo Nishidai, Aichi (JP); Naoyuki Ishihara, Aichi (JP); Yosuke Tomita, Aichi (JP)

(72) Inventors: Tetsuo Nishidai, Aichi (JP); Naoyuki Ishihara, Aichi (JP); Yosuke Tomita, Aichi (JP)

(73) Assignee: OMRON AUTOMOTIVE ELECTRONICS CO., LTD., Aichi (JP)

(21) Appl. No.: 15/426,633

(22) Filed: Feb. 7, 2017

(30) Foreign Application Priority Data
Feb. 12, 2016 (JP) 2016-025001

(51) Int. Cl. B60R 25/24; B60R 25/23

(52) U.S. Cl. CPC B60R 25/24; B60R 25/23; B60R 2325/205

(57) ABSTRACT

A vehicle control system includes a vehicle control apparatus mounted on a vehicle, a first portable device (electronic key) performing communication with the vehicle control apparatus, and a second portable device (smartphone) performing communication with the first portable device. The second portable device transmits, based on a predetermined operation by a user, a notification signal notifying about the operation to the first portable device. When the first portable device receives the notification signal from the second portable device, the first portable device transmits the notification signal with an identification code of the first portable device to the vehicle control apparatus. When the vehicle control apparatus detects a gesture of the user after receiving the notification signal and the identification code from the first portable device, the vehicle control apparatus extracts a feature of the gesture from a detection signal, and stores the feature to be associated with the identification code.

### CROSS-REFERENCE TO RELATED APPLICATION

This application is based on Japanese Patent Application No. 2016-025001 filed with the Japan Patent Office on Feb. 12, 2016, the entire contents of which are incorporated herein by reference.

### FIELD

The disclosure relates to a vehicle control system that includes a control apparatus included in a vehicle; and a portable device carried by a user of the vehicle. More particularly, the disclosure relates to a vehicle control system having a function of automatically opening and closing a door by detecting a user's predetermined gesture.

### BACKGROUND

There is known a door opening and closing system in which, even when a user has his/her hands full, a sliding door, a rear door, etc., of a vehicle can be automatically opened or closed by detecting a gesture such as a user's leg motion. In the system, a kick sensor that detects a leg motion is provided underneath the sliding door or rear door. When the user, for example, stands near the sliding door and performs a movement of kicking out his/her leg such that an end of the leg is put into a space between a vehicle body and the ground, the kick sensor detects the leg motion, and the sliding door is automatically opened or closed based on a detection signal outputted from the kick sensor. JP 2014-500414 W discloses a door opening and closing system including such a kick sensor.

In addition, JP 2013-7171 A discloses a system that automatically opens and closes a door by detecting a gesture using an obstacle sensor such as laser radar. In the system, an obstacle sensor for detecting an obstacle in an opening/closing path of a door is provided to a door mirror, etc., and the door is automatically opened or closed based on detection of a user's hand or leg motion by the obstacle sensor.

However, the mode of a hand or leg gesture varies from user to user. For example, when a leg motion is detected by a kick sensor, some users may kick out their legs quickly and some users may kick out their legs slowly. In addition, some users may lift up their legs high and some users may not lift up their legs so high. Conventionally, however, a detection criterion for detection of performing of a predetermined gesture (e.g., a threshold for an output voltage of the kick sensor) is preset as a fixed value. Hence, the kick sensor may not respond depending on the user's gesture habit, which may cause trouble in automatic opening and closing of a door.

### SUMMARY

An object of the disclosure is to provide a vehicle control system capable of performing smooth automatic opening and closing of a vehicle door, taking into account a user's gesture habit.

A vehicle control system according to one or more embodiments of the disclosure includes a vehicle control apparatus mounted on a vehicle; and a portable device carried by a user. The vehicle control apparatus includes: a door driving unit configured to open and close a door of the vehicle; a detector configured to detect a gesture of the user; and a controller configured to determine, based on a detection signal, whether a predetermined gesture is performed, and allow the door driving unit to open or close the door when the predetermined gesture is performed, the detection signal being outputted from the detector. The portable device includes: a first portable device configured to perform communication with the vehicle control apparatus; and a second portable device configured to perform communication with the first portable device. The second portable device transmits, based on a fact that a predetermined operation by the user is performed, a notification signal to the first portable device, the notification signal notifying about the predetermined operation. When the first portable device receives the notification signal from the second portable device, the first portable device transmits the notification signal together with an identification code of the first portable device to the vehicle control apparatus. When the vehicle control apparatus detects, by the detector, a gesture of the user after receiving the notification signal and the identification code from the first portable device, the vehicle control apparatus extracts a feature of the gesture from a detection signal for the gesture, and stores the feature so as to be associated with the identification code. The controller determines whether the predetermined gesture is performed, based on a result of a comparison between a feature extracted from a detection signal for a subsequent gesture and the stored feature.

According to the vehicle control system, the user can customize the detection criteria of the detector according to his/her gesture habit, only by performing a predetermined operation on the second portable device and then performing a gesture such as a kick movement. Hence, the vehicle control apparatus can accurately detect a gesture regardless of who the user is, and can perform smooth automatic opening and closing of the door.

In one or more embodiments of the disclosure, the first portable device may be an electronic key for locking or unlocking a door of the vehicle, and the second portable device may be a smartphone that performs near-field wireless communication with the first portable device.

In one or more embodiments of the disclosure, the first portable device and the second portable device may be integrated. A vehicle control system in this case includes a vehicle control apparatus and a single portable device carried by a user. The portable device transmits, based on a fact that a predetermined operation by the user is performed, a notification signal together with an identification code of the portable device to the vehicle control apparatus, the notification signal notifying about the predetermined operation. When the vehicle control apparatus detects, by the detector, a gesture of the user after receiving the notification signal and the identification code from the portable device, the vehicle control apparatus extracts a feature of the gesture from a detection signal for the gesture, and stores the feature so as to be associated with the identification code. The controller determines whether the predetermined gesture is performed, based on a result of a comparison between a feature extracted from a detection signal for a subsequent gesture and the stored feature.

In this case, too, the portable device may be a smartphone or may be an electronic key for locking or unlocking the door of the vehicle.

In one or more embodiments of the disclosure, the feature of the gesture may include at least one of a peak value of the detection signal, time taken for the detection signal to reach the peak value, and a change rate at a rise of the detection signal.

When the feature includes a peak value of the detection signal, a predetermined threshold may be set for the peak value.

According to one or more embodiments of the disclosure, a vehicle control system can be provided that is capable of performing smooth automatic opening and closing of a vehicle door, taking into account a user's gesture habit.

### BRIEF DESCRIPTION OF THE DRAWINGS

FIG. 1 is a schematic diagram of a vehicle control system according to a first embodiment;

FIG. 2 is a diagram describing a kick movement;

FIG. 3 is a diagram showing a detection signal of a kick sensor;

FIG. 4 is a block diagram of the vehicle control system according to the first embodiment;

FIG. 5 is a flowchart showing the operation of the vehicle control system according to the first embodiment;

FIG. 6A is a diagram showing an initial screen of a portable device;

FIG. 6B is a diagram showing a selection screen of the portable device;

FIG. 6C is a diagram showing a navigation screen of the portable device;

FIG. 6D is a diagram showing another example of a navigation screen of the portable device;

FIG. 6E is a diagram showing a setting completion notification screen of the portable device;

FIG. 6F is a diagram showing a setting cancellation notification screen of the portable device;

FIGS. 7A and 7B are diagrams showing features extracted from a detection signal of the kick sensor;

FIG. 8 is a flowchart showing procedural steps for door opening and closing operation;

FIG. 9 is a schematic diagram of a vehicle control system according to a second embodiment;

FIG. 10 is a block diagram of the vehicle control system according to the second embodiment;

FIG. 11 is a flowchart showing the operation of the vehicle control system according to the second embodiment;

FIG. 12 is a schematic diagram of a vehicle control system according to a third embodiment; and

FIG. 13 is a block diagram of the vehicle control system according to the third embodiment.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

### First Embodiment

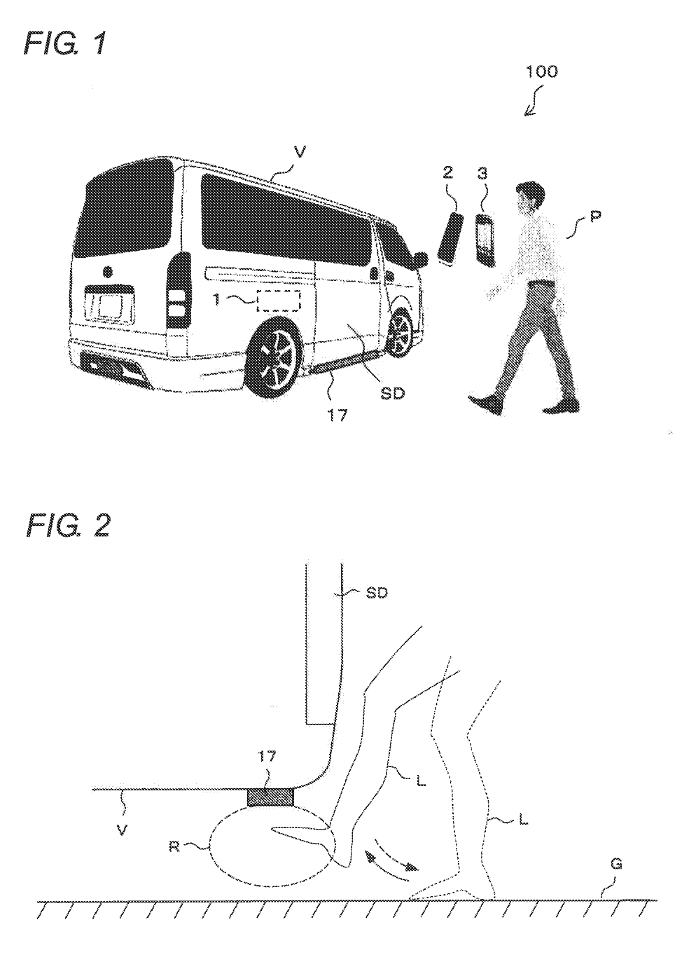

A configuration of a vehicle control system according to a first embodiment will be described with reference to FIG. 1 to FIG. 4. As shown in FIG. 1, a vehicle control system 100 includes a vehicle control apparatus 1 mounted on a vehicle V; an electronic key 2 that performs wireless communication with the vehicle control apparatus 1; and a smartphone 3 that performs wireless communication with the electronic key 2. The electronic key 2 and the smartphone 3 are carried by a user (passenger) P of the vehicle V. A kick sensor 17 is provided underneath a sliding door SD of the vehicle V.

Here, the electronic key 2 is an example of a “first portable device” in one or more embodiments of the disclosure, and the smartphone 3 is an example of a “second portable device” in one or more embodiments of the disclosure.

The kick sensor 17 is composed of, for example, a capacitive proximity sensor. As shown in FIG. 2, the kick sensor 17 has a predetermined detection range R. The user P stands beside the sliding door SD and kicks out his/her leg L such that an end of the leg L is put into a space between the vehicle V and ground G, as indicated by a solid-line arrow, and then pulls his/her leg L back, as indicated by a dashed-line arrow. A series of those movements is hereinafter referred to as “kick movement”. By the leg L getting into and out of the detection range R by the kick movement, the capacitance of the kick sensor 17 changes, and the kick sensor 17 outputs a detection signal. The kick movement is an example of a “gesture” in one or more embodiments of the disclosure.

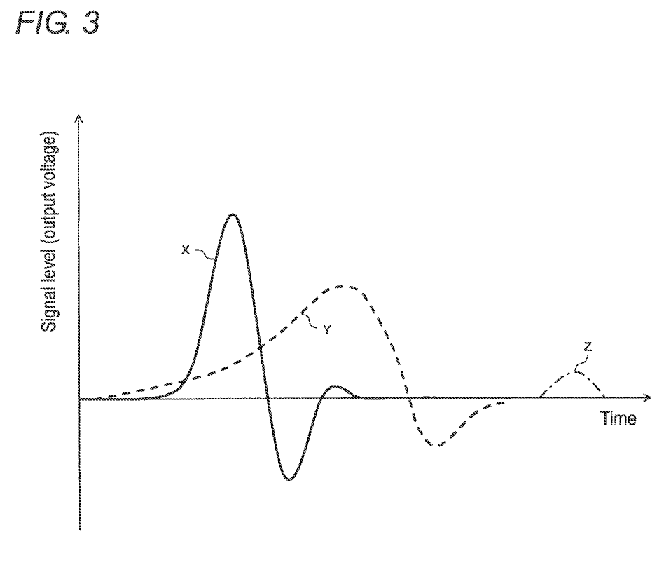

FIG. 3 shows an example of a detection signal outputted from the kick sensor 17 by a kick movement. A vertical axis represents a signal level (output voltage) of the detection signal, and a horizontal axis represents time. X indicates a pattern that is often seen when males perform a kick movement. The detection signal has such a waveform as that of X when a user quickly kicks his/her leg up to a high position and then quickly pulls it back. Y indicates a pattern that is often seen when females perform a kick movement. The detection signal has such a waveform as that of Y when a user slowly kicks up his/her leg to a not-so-high position and then slowly pulls it back. Z indicates a pattern for a case in which an animal such as a dog or a cat cuts across near the kick sensor 17, and is clearly different from the X and Y patterns.

As such, since the pattern of a detection signal of the kick sensor 17 varies depending on the user, if detection criteria for detection of a kick movement by the kick sensor 17 are fixed, then an event may occur where a kick movement can be detected for a certain user, but cannot be detected for another user. In the disclosure, on the other hand, as will be described in detail later, the detection criteria of the kick sensor 17 are customized according to a user, by which a kick movement can be accurately detected regardless of who the user is.

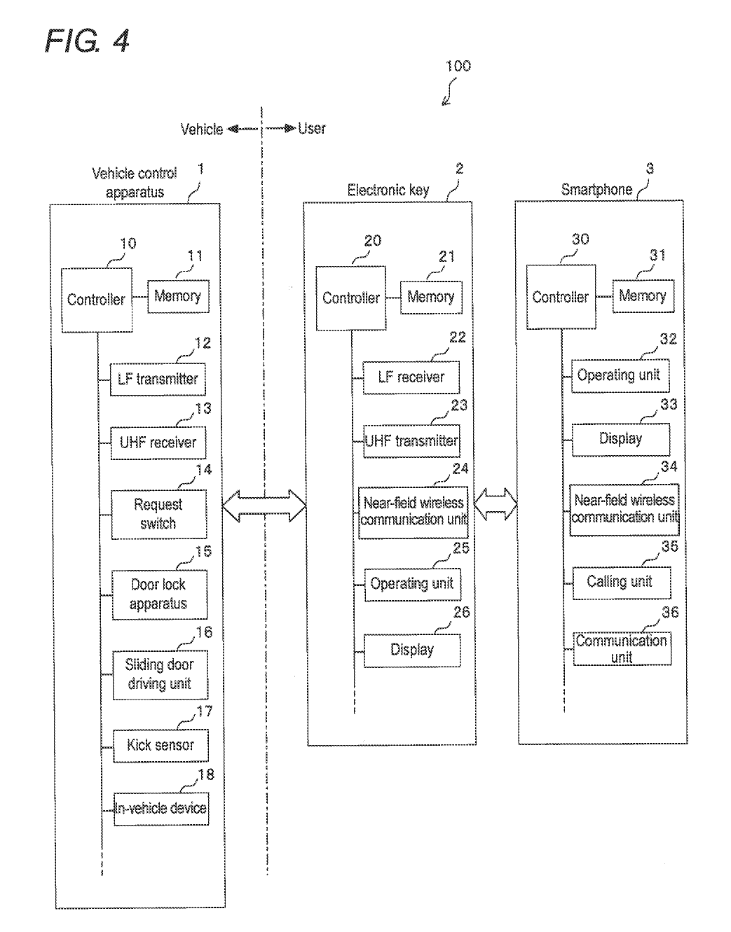

FIG. 4 shows specific configurations of the vehicle control apparatus 1, the electronic key 2, and the smartphone 3, each of which will be described in detail below.

The vehicle control apparatus 1 includes a controller 10, a memory 11, an LF (Low Frequency) transmitter 12, a UHF (Ultra High Frequency) receiver 13, a request switch 14, a door lock apparatus 15, a sliding door driving unit 16, a kick sensor 17, and an in-vehicle device 18. Although the vehicle control apparatus 1 includes various types of blocks in addition to those, they are not directly related to the disclosure and thus are not shown. Note that the vehicle control system 100 of FIG. 2 is not only a keyless entry system that performs the locking or unlocking of the doors by operating the electronic key 2, but also a passive entry system that performs the locking or unlocking of the doors by performing communication between the vehicle control apparatus 1 and the electronic key 2 when the user has approached or touched a door knob.

The controller 10 includes a CPU and controls the operation of the vehicle control apparatus 1. The memory 11 includes memories such as a ROM and a RAM. The LF transmitter 12 intermittently transmits, in a predetermined cycle, an LF signal for checking the presence of the electronic key 2. The UHF receiver 13 receives a UHF signal (described later) which is transmitted from the electronic key 2. The request switch 14 forms a passive entry system, together with the electronic key 2. The request switch 14 is provided near a door knob and detects a user's approach or touch. The door lock apparatus 15 includes, for example, a lock mechanism that locks and unlocks doors of the vehicle V; and a drive circuit that allows the lock mechanism to operate. The sliding door driving unit 16 includes, for example, a motor for opening and closing the sliding door SD (FIG. 1), and a drive circuit that drives the motor. The kick sensor 17 is as described above. The in-vehicle device 18 includes lighting, an air conditioning apparatus, an audio apparatus, a car navigation apparatus, etc.

Here, the sliding door driving unit 16 is an example of a “door driving unit” in one or more embodiments of the disclosure, and the kick sensor 17 is an example of a “detector” in one or more embodiments of the disclosure.

The electronic key 2 includes a controller 20, a memory 21, an LF receiver 22, a UHF transmitter 23, a near-field wireless communication unit 24, an operating unit 25, and a display 26. Although the electronic key 2 also includes other blocks than those, they are not directly related to the disclosure and thus are not shown.

The controller 20 includes a CPU and controls the operation of the electronic key 2. The memory 21 includes memories such as a ROM and a RAM. The LF receiver 22 receives the above-described LF signal which is transmitted from the LF transmitter 12 of the vehicle control apparatus 1. The UHF transmitter 23 transmits commands (described later) to the vehicle control apparatus 1 by UHF communication. The near-field wireless communication unit 24 includes a communication circuit for near-field wireless communication such as a wireless LAN or Bluetooth (registered trademark). The operating unit includes a plurality of operating buttons provided to a main body of the electronic key 2. The display 26 includes a plurality of LED lamps provided to the main body of the electronic key 2.

The smartphone 3 includes a controller 30, a memory 31, an operating unit 32, a display 33, a near-field wireless communication unit 34, a calling unit 35, and a communication unit 36. Although the smartphone 3 includes various types of blocks in addition to those, they are not directly related to the disclosure and thus are not shown.

The controller 30 includes a CPU and controls the operation of the smartphone 3. The memory 31 includes memories such as a ROM and a RAM. The operating unit 32 includes operating buttons provided to a main body of the smartphone 3 and operating buttons displayed on the display 33. The display 33 includes, for example, a liquid crystal panel provided to the main body of the smartphone 3 and a drive circuit for the liquid crystal panel. The near-field wireless communication unit 34 includes a communication circuit which is the same as that of the near-field wireless communication unit 24 of the electronic key 2. The calling unit 35 includes a speaker, a microphone, an audio circuit, and the like. The communication unit 36 includes a communication circuit that is connected to an Internet line to perform communication with a server, etc.

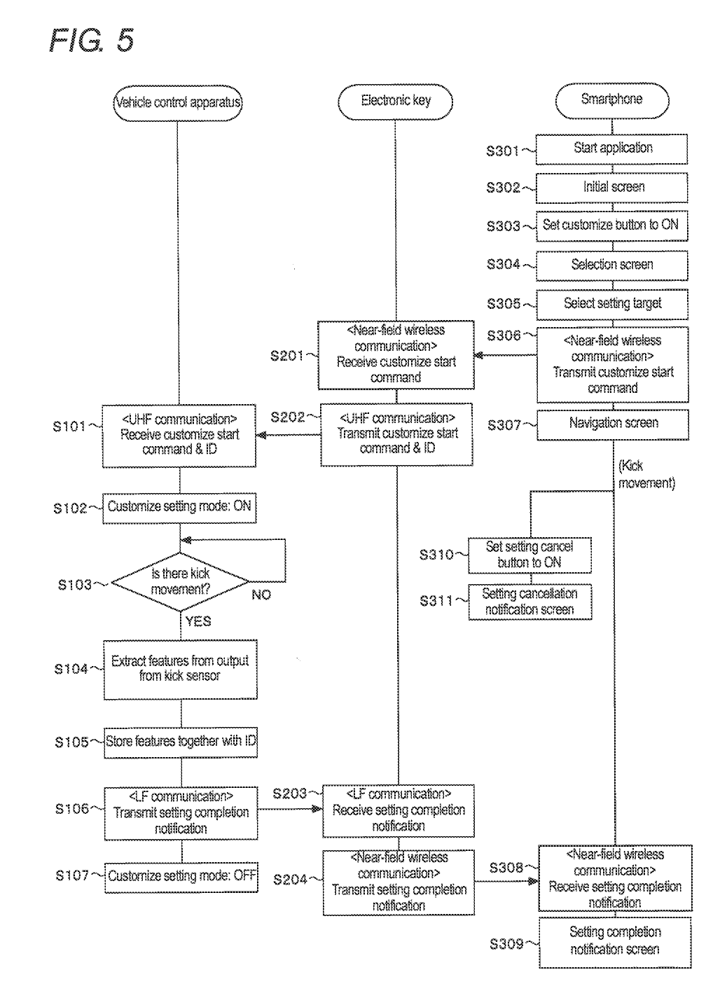

Next, procedural steps for customizing the detection criteria of the kick sensor 17 in the vehicle control system 100 configured in the above-described manner will be described with reference to a flowchart of FIG. 5. Note that a condition for customization of the detection criteria is that the user P carries both the electronic key 2 and the smartphone 3.

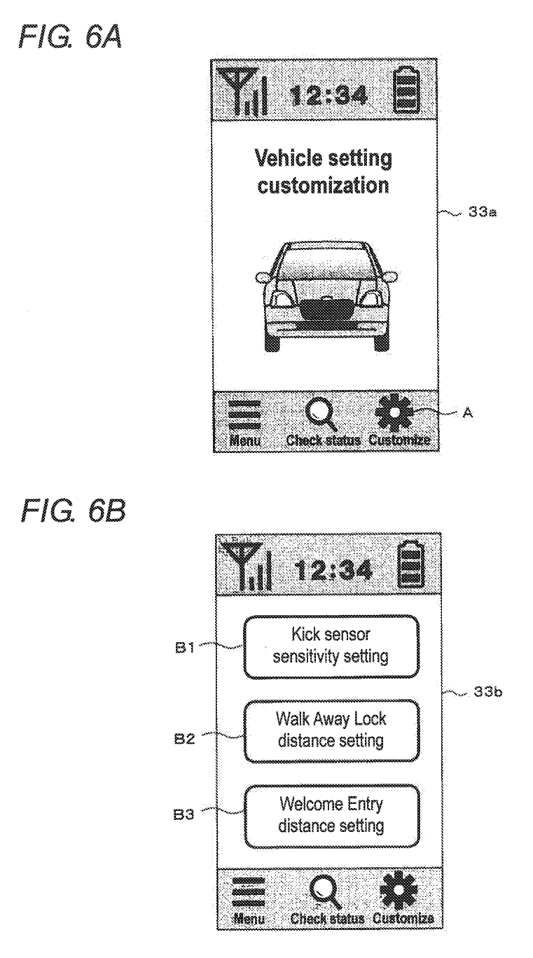

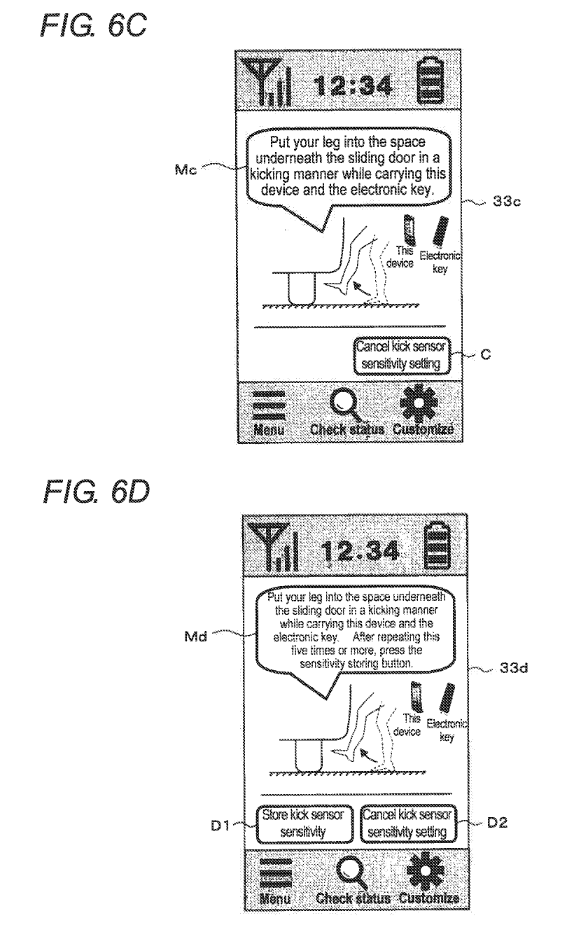

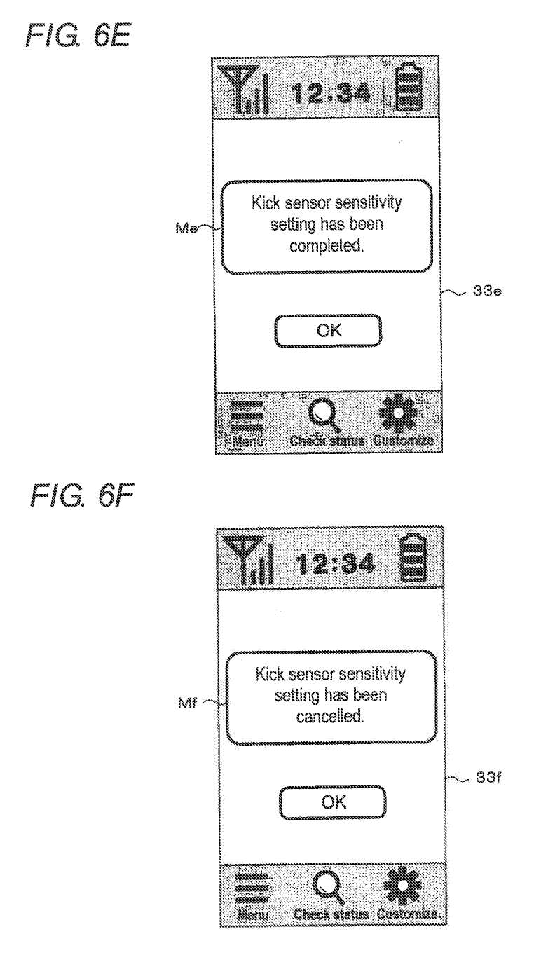

When the detection criteria are customized, the user P first starts an application for customization by operating the smartphone 3 (step S301). By doing so, an initial screen 33a such as that shown in FIG. 6A is displayed on the display 33 of the smartphone 3 (step S302). Subsequently, when the user P presses a customize button A displayed on the initial screen 33a (step S303), the screen on the display 33 changes to a selection screen 33b such as that shown in FIG. 6B (step S304). The selection screen 33b displays buttons B1 to B3 for selecting a setting target.

When the user P selects a setting target by pressing the kick sensor sensitivity setting button B1 on the selection screen 33b (step S305), the near-field wireless communication unit 34 of the smartphone 3 transmits a customize start command that instructs to start the sensitivity (detection criteria) setting of the kick sensor 17, to the near-field wireless communication unit 24 of the electronic key 2 (step S306). When the electronic key 2 receives the customize start command by the near-field wireless communication unit 24 (step S201), the electronic key 2 transmits the customize start command together with an identification code (hereinafter, referred to as “ID”) of the electronic key 2, as a UHF signal, from the UHF transmitter 23 to the vehicle control apparatus 1 (step S202). The ID of the electronic key 2 is prestored in the memory 21.

Here, the pressing of the kick sensor sensitivity setting button B1 is an example of a “predetermined operation” in one or more embodiments of the disclosure. The customize start command is a signal notifying about the pressing of the kick sensor sensitivity setting button B1, and is an example of a “notification signal” in one or more embodiments of the disclosure.

When the vehicle control apparatus 1 receives, by the UHF receiver 13, the customize start command and ID transmitted from the electronic key 2 (step S101), the vehicle control apparatus 1 sets a customize setting mode to ON (step S102). Thereafter, the vehicle control apparatus 1 waits for the kick sensor 17 to detect a kick movement (step S103).

On the other hand, on the smartphone 3, by the selection of the kick sensor sensitivity setting at step S305, the screen on the display 33 changes to a navigation screen 33c such as that shown in FIG. 6C (step S307). The navigation screen 33c displays a message Mc prompting the user P to perform a kick movement while carrying the smartphone 3 and the electronic key 2, and a setting cancel button C. By following the message Mc, the user P performs a kick movement shown in FIG. 2, carrying the electronic key 2 and the smartphone 3.

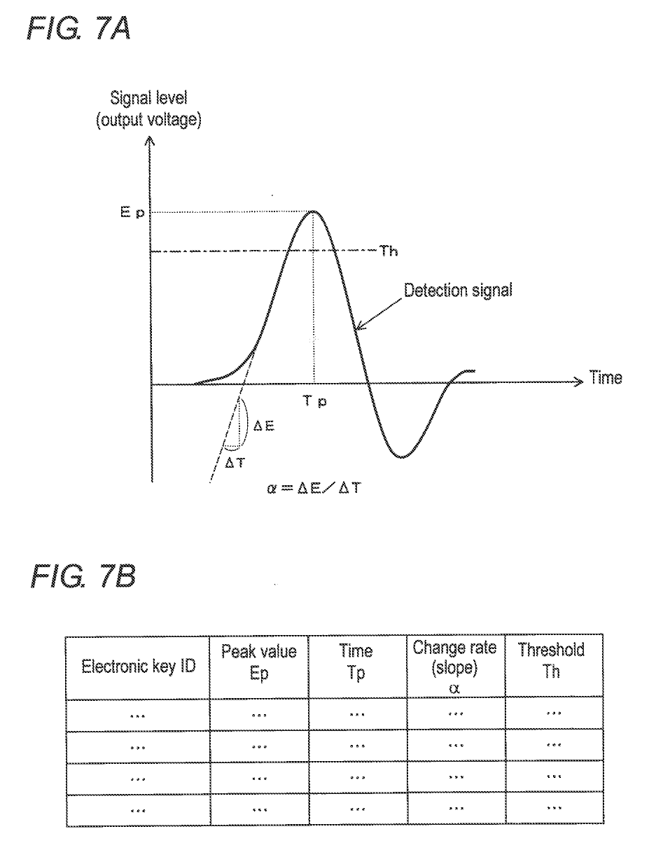

If the vehicle control apparatus 1 detects, by the kick sensor 17, the above-described kick movement (step S103; YES), the controller 10 analyzes a detection signal outputted from the kick sensor 17, and extracts features of the kick movement (step S104). The features are considered to include, for example, a peak value Ep of the detection signal, time Tp taken for the detection signal to reach the peak value Ep, and a change rate (slope) α at a rise of the detection signal, such as those shown in FIG. 7A. The features may include all of them or may include some of them. For example, only the peak value Ep may be used as a feature, or the peak value Ep and the time Tp, or the peak value Ep and the change rate α may be used as features. In addition, a predetermined threshold Th may be set for the peak value Ep.

The controller 10 stores, in the memory 11, the above-described features together with the ID of the electronic key 2 (step S105). The memory 11 is provided with, for example, a table such as that shown in FIG. 7B. In the table, the features are stored so as to be associated with IDs. When each family member owns an electronic key 2, an ID is assigned to each electronic key. Thus, the table of FIG. 7B stores, for a plurality of IDs, individuals' features. The features thus stored serve as detection criteria for detection of a kick movement by the kick sensor 17. The detection criteria are customized according to individuals' kick movement habits.

When storing of the features is done, the vehicle control apparatus 1 transmits a signal notifying about the completion of feature setting, to the electronic key 2 (step S106). The signal is transmitted, as an LF signal, from the LF transmitter 12. The reason that the LF signal is transmitted is because by using a low-frequency magnetic field, a communication area around the vehicle is limited to a range on the order of two meters from the vehicle, improving security. Thereafter, the vehicle control apparatus 1 sets the customize setting mode to OFF (step S107).

When the electronic key 2 receives, by the LF receiver 22, the LF signal transmitted from the vehicle control apparatus 1 (step S203), the electronic key 2 transmits a signal notifying about the completion of feature setting, from the near-field wireless communication unit 24 to the smartphone 3 (step S204).

When the near-field wireless communication unit 34 of the smartphone 3 receives the signal (step S308), the screen on the display 33 of the smartphone 3 changes to a setting completion notification screen 33e such as that shown in FIG. 6E (step S309). The screen displays a message Me notifying about the completion of setting.

FIG. 6D shows another example of a navigation screen displayed at step S307. This navigation screen 33d displays a message Md prompting the user P to perform a kick movement a plurality of times (here, five times or more) while carrying the smartphone 3 and the electronic key 2, and a sensitivity storing button D1 and a setting cancel button D2. By following the message Md, the user P performs a kick movement a predetermined number of times, carrying the electronic key 2 and the smartphone 3, and then presses the sensitivity storing button D1. By this, the smartphone 3 transmits a signal notifying about the completion of a kick movement, to the vehicle control apparatus 1 through the electronic key 2. The vehicle control apparatus 1 having received the signal performs the processes at and after step S104. When customization is thus performed based on a plurality of kick movements, for example, average values of features detected for each kick movement may be calculated, and the average values may be stored as features (detection criteria). By this, kick movement detection accuracy can be increased.

When the user P presses the setting cancel buttons C and D2 on the navigation screens 33c and 33d of FIGS. 6C and 6D (step S310), the screen of the smartphone 3 changes to a setting cancellation notification screen 33f such as that shown in FIG. 6F (step S311). The screen displays a message Mf notifying about the cancellation of setting.

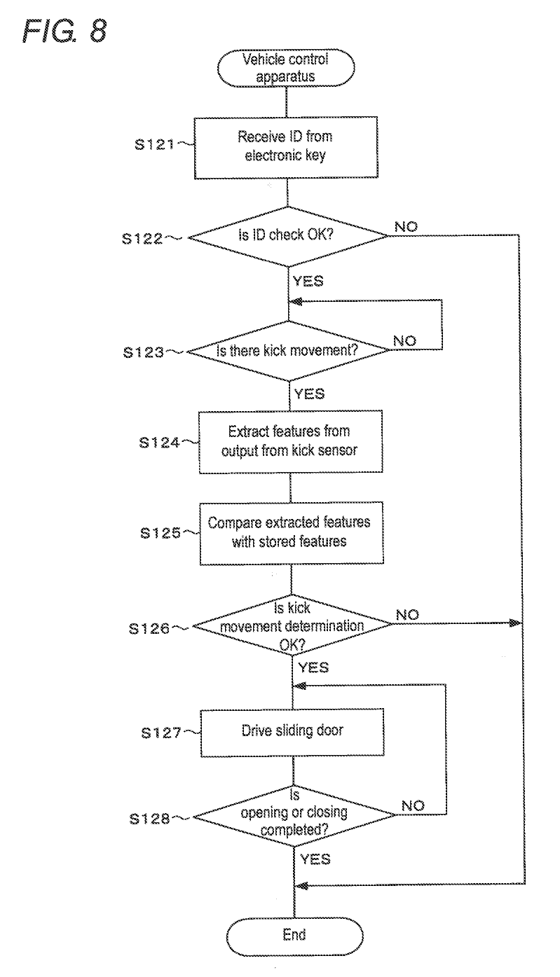

By the above, the operation of customizing the detection criteria (features) of the kick sensor 17 is completed. After this, opening and closing of the sliding door SD by a kick movement at normal times are performed according to procedural steps of a flowchart of FIG. 8.

In FIG. 8, when the vehicle control apparatus 1 receives, by the UHF receiver 13, an ID transmitted from the electronic key 2 (step S121), the vehicle control apparatus 1 checks the ID (step S122). Specifically, the vehicle control apparatus 1 compares the ID received from the electronic key 2 with the ID of the electronic key 2 stored in the memory 11, to determine whether the IDs match. Then, if the IDs do not match, the check fails (step S122; NO) and the process ends. On the other hand, if the IDs match, the check succeeds (step S122; YES), and the vehicle control apparatus 1 waits for a kick movement to be detected (step S123).

When the user P performs a kick movement and the kick sensor 17 detects the kick movement (step S123; YES), the controller 10 analyzes a detection signal of the kick sensor 17 and extracts features described in FIG. 7A (step S124). Then, the controller 10 compares the extracted features with features associated with the corresponding ID in the memory 11 (FIG. 7B) (step S125). Based on the comparison results, the controller 10 determines whether the detected kick movement matches that of the ID (step S126). For example, the controller 10 computes a difference between a detected value of each feature and a corresponding stored value. When the difference is within a certain range, the determination is OK, and when the difference is not within the certain range, the determination is NG.

If the kick movement determination is OK (step S126; YES), the controller 10 allows the sliding door driving unit 16 to drive the sliding door SD (step S127). If opening or closing of the sliding door SD is completed (step S128; YES), the controller 10 ends a series of processes. If the kick movement determination is NG (step S126; NO), the controller 10 ends a series of processes without performing steps S127 and S128.

Note that a determination as to whether to open or close the sliding door SD by a kick movement can be made as follows. Specifically, when a kick movement is performed with the sliding door SD being closed which is detected by a door sensor (not shown), the sliding door driving unit 16 opens the sliding door SD. On the other hand, when a kick movement is performed with the sliding door SD being opened which is detected by the door sensor, the sliding door driving unit 16 closes the sliding door SD.

According to the above-described first embodiment, the user P can customize the detection criteria of the kick sensor 17 according to his/her kick movement habit, only by pressing the kick sensor sensitivity setting button B1 on the smartphone 3 and then performing a kick movement. Hence, the vehicle control apparatus 1 can accurately detect a kick movement regardless of who the user is, and can perform smooth automatic opening and closing of the sliding door SD.

In addition, in the first embodiment, since the electronic key 2 and the smartphone 3 are used as portable devices and a signal is transmitted from the smartphone 3 to the vehicle control apparatus 1 through the electronic key 2, the electronic key 2 serves as a gateway. Hence, compared to a case in which a signal is directly transmitted to the vehicle control apparatus 1 from the smartphone 3 connected to the Internet, security performance on the vehicle side can be enhanced.

### Second Embodiment

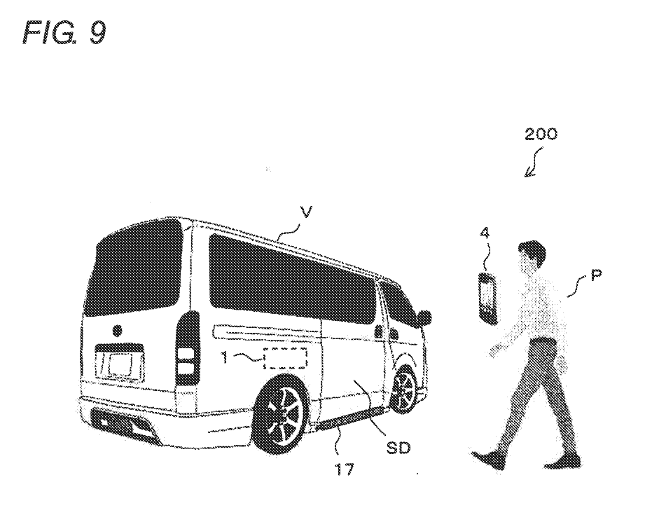

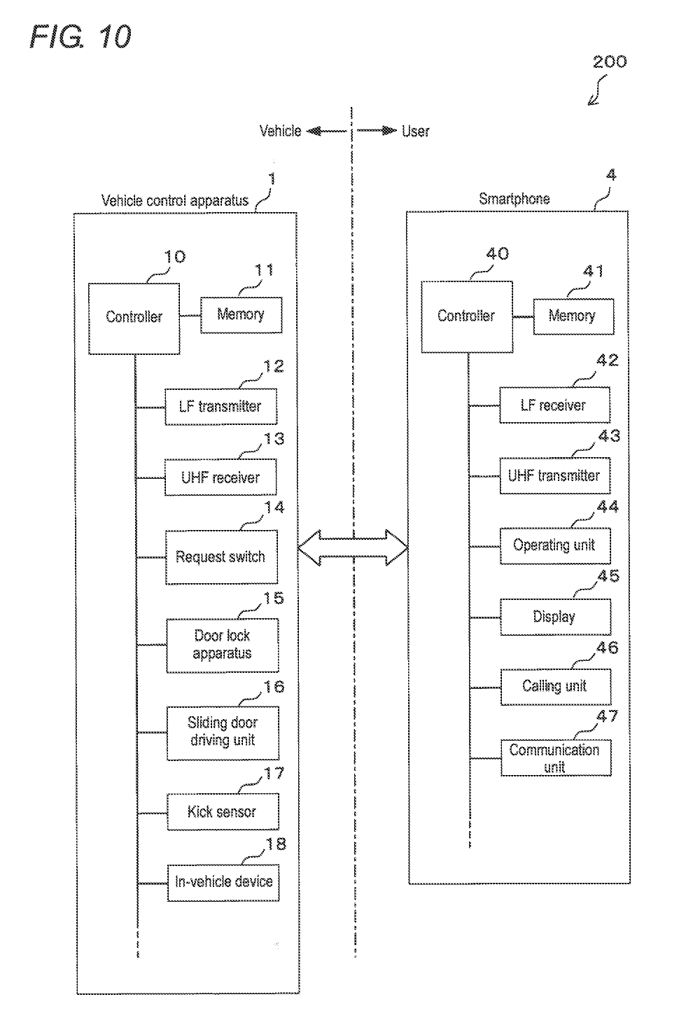

Next, a configuration of a vehicle control system according to a second embodiment will be described with reference to FIGS. 9 and 10. As shown in FIG. 9, a vehicle control system 200 includes a vehicle control apparatus 1 mounted on a vehicle V; and a smartphone 4 that performs wireless communication with the vehicle control apparatus 1. The smartphone 4 is carried by a user (passenger) P of the vehicle V. In the second embodiment, the smartphone 4 also serves as an electronic key. The smartphone 4 is an example of a “portable device” in one or more embodiments of the disclosure.

FIG. 10 shows specific configurations of the vehicle control apparatus 1 and the smartphone 4. The configuration of the vehicle control apparatus 1 is the same as that of FIG. 4 and thus description thereof is omitted. The smartphone 4 includes a controller 40, a memory 41, an LF receiver 42, a UHF transmitter 43, an operating unit 44, a display 45, a calling unit 46, and a communication unit 47. Although the smartphone 4 includes various types of blocks in addition to those, they are not directly related to the disclosure and thus are not shown.

The controller 40 includes a CPU and controls the operation of the smartphone 4. The memory 41 includes memories such as a ROM and a RAM. The LF receiver 42 receives an LF signal for checking the presence of the smartphone 4, which is transmitted from the LF transmitter 12 of the vehicle control apparatus 1. The UHF transmitter 43 transmits commands (described later) to the vehicle control apparatus 1 by UHF communication. The operating unit 44 includes operating buttons provided to a main body of the smartphone 4 and operating buttons displayed on the display 45. The display 45 includes, for example, a liquid crystal panel provided to the main body of the smartphone 4 and a drive circuit for the liquid crystal panel. The calling unit 46 includes a speaker, a microphone, an audio circuit, and the like. The communication unit 47 includes a communication circuit that is connected to an Internet line to perform communication with a server, etc.

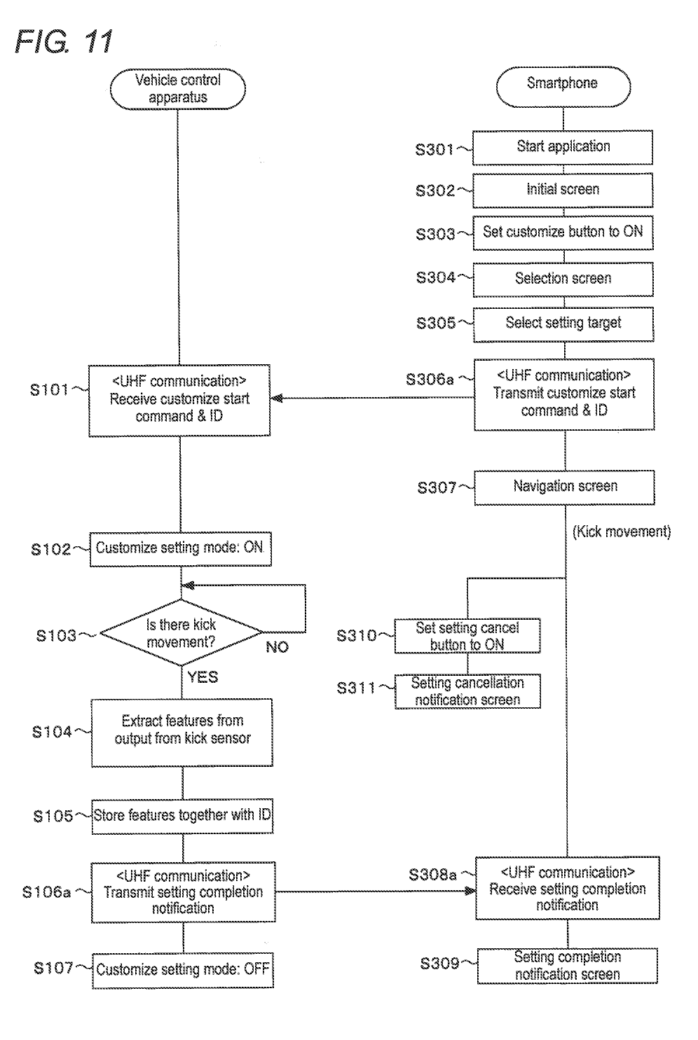

A flowchart of FIG. 11 shows procedural steps for customizing the detection criteria of the kick sensor 17 in the vehicle control system 200 configured in the above-described manner. In FIG. 11, those steps that perform the same processes as in FIG. 5 are denoted by the same reference signs.

In FIG. 11, procedural steps S101 to S105 and S107 for the vehicle control apparatus 1 are the same as those for the case of the first embodiment (FIG. 3), and thus, description thereof is omitted. In addition, procedural steps S301 to S305, S307, and S309 to S311 for the smartphone 4 are also the same as those for the case of the first embodiment, and thus, description thereof is omitted and only differences from the first embodiment will be described below. Note that screens to be displayed on the display 45 of the smartphone 4 are the same as those shown in FIGS. 6A to 6F, except that those portions related to an electronic key are omitted.

In the first embodiment, a customize start command is transmitted to the electronic key 2 by near-field wireless communication at step S306 of FIG. 5. In the second embodiment, on the other hand, a customize start command is transmitted to the vehicle control apparatus 1 by UHF communication at step S306a of FIG. 11.

In addition, in the first embodiment, the vehicle control apparatus 1 transmits a signal notifying about the completion of feature setting, as an LF signal, to the electronic key 2 at step S106 of FIG. 5. In the second embodiment, on the other hand, the vehicle control apparatus 1 transmits a signal notifying about the completion of feature setting, as a UHF signal, to the smartphone 4 at step S106a of FIG. 11.

In addition, in the first embodiment, the smartphone 3 receives a signal notifying about the completion of feature setting from the electronic key 2 by near-field wireless communication at step S308 of FIG. 5. In the second embodiment, on the other hand, the smartphone 4 receives a signal notifying about the completion of feature setting, as a UHF signal, from the vehicle control apparatus 1 at step S308a of FIG. 11.

Note that, in the second embodiment, procedural steps for opening and closing the sliding door SD by a kick movement at normal times after customizing the kick movement detection criteria are the same as those shown in the flowchart of FIG. 8.

As another example of the second embodiment, instead of the LF receiver 42 and the UHF transmitter 43 of the smartphone 4 of FIG. 10, the near-field wireless communication unit 34 of FIG. 4 may be provided, and the same near-field wireless communication unit may also be provided to the vehicle control apparatus 1, and communication may be performed therebetween.

According to the above-described second embodiment, as in the first embodiment, the vehicle control apparatus 1 can accurately detect a kick movement regardless of who the user is, and can perform smooth automatic opening and closing of the sliding door SD. In addition, since the portable device is only the smartphone 4, the system can be simplified.

### Third Embodiment

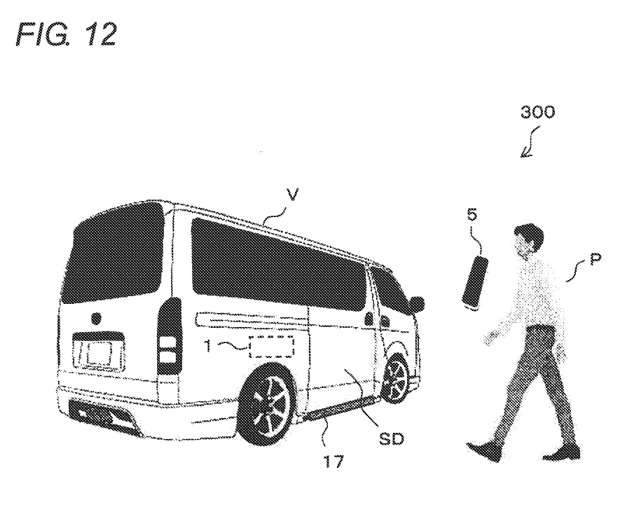

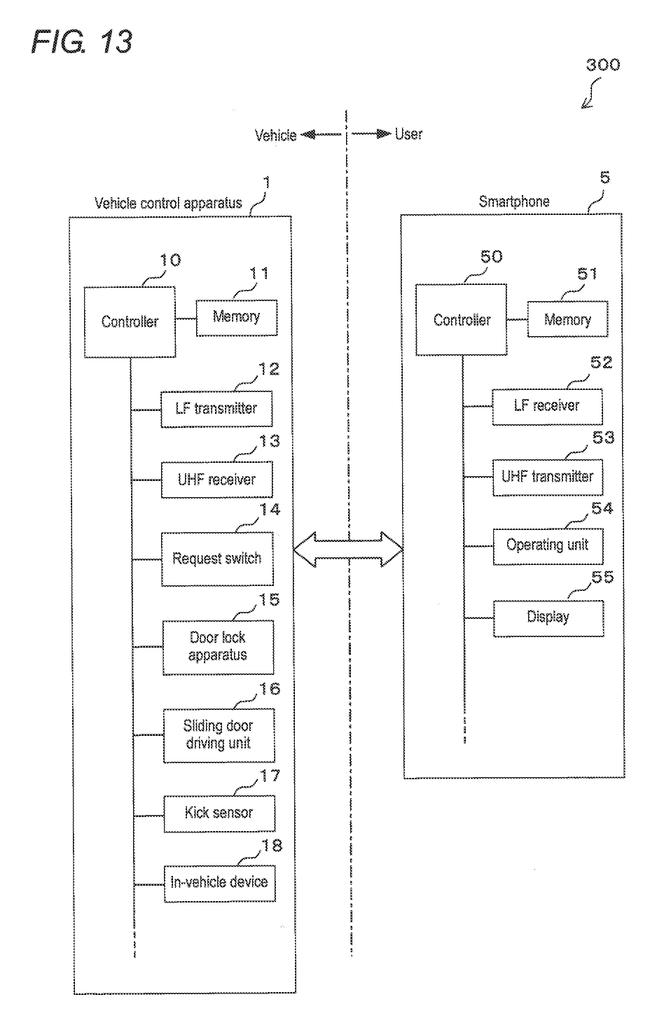

Next, a configuration of a vehicle control system according to a third embodiment will be described with reference to FIGS. 12 and 13. As shown in FIG. 12, a vehicle control system 300 includes a vehicle control apparatus 1 mounted on a vehicle V; and an electronic key 5 that performs wireless communication with the vehicle control apparatus 1. The electronic key 5 is carried by a user (passenger) P of the vehicle V. In the third embodiment, the electronic key 5 has the function of setting sensitivity (detection criteria). The electronic key 5 is an example of the “portable device” in one or more embodiments of the disclosure.

FIG. 13 shows specific configurations of the vehicle control apparatus 1 and the electronic key 5. The configuration of the vehicle control apparatus 1 is the same as that of FIG. 4 and thus description thereof is omitted. The electronic key 5 includes a controller 50, a memory 51, an LF receiver 52, a UHF transmitter 53, an operating unit 54, and a display 55. Although the electronic key 5 also includes other blocks than those, they are not directly related to the disclosure and thus are not shown.

The controller 50 includes a CPU and controls the operation of the electronic key 5. The memory 51 includes memories such as a ROM and a RAM. The LF receiver 52 receives an LF signal for checking the presence of the electronic key 5 which is transmitted from the LF transmitter 12 of the vehicle control apparatus 1. The UHF transmitter 53 transmits the aforementioned customize start command to the vehicle control apparatus 1 by UHF communication. The operating unit 54 includes, for example, a plurality of operating buttons provided to a main body of the electronic key 5. The display 55 includes, for example, a plurality of LED lamps provided to the main body of the electronic key 5.

The vehicle control system 300 of the third embodiment does not use a smartphone and thus screen display is not performed for operations. However, it is possible to allow the user P to perform operations required for customization of the detection criteria by using the operating buttons of the operating unit 54 or the LED lamps of the display 55 which are included in the electronic key 5.

Procedural steps for customizing the detection criteria of the kick sensor 17 in the vehicle control system 300 configured in the above-described manner are basically the same as those of FIG. 11, except that the smartphone 4 of the second embodiment is replaced by the electronic key 5 and the electronic key 5 does not perform screen display, and can be easily inferred from FIG. 11, and thus, description thereof is omitted.

In addition, in the third embodiment, procedural steps for opening and closing the sliding door SD by a kick movement at normal times after customizing the kick movement detection criteria are the same as those shown in the flowchart of FIG. 8.

According to the above-described third embodiment, as in the first embodiment, the vehicle control apparatus 1 can accurately detect a kick movement regardless of who the user is, and can perform smooth automatic opening and closing of the sliding door SD. In addition, since the portable device is only the electronic key 5, the system can be simplified as in the second embodiment.

### Other Embodiments

The disclosure can adopt various embodiments such as those shown below in addition to the above-described ones.

Although features (detection criteria) are stored in the memory 11 of the vehicle control apparatus 1 at step S105 of FIGS. 5 and 11, the features (detection criteria) may be stored in the memory 21 of the electronic key 2 or in the memory 31, 41 of the smartphone 3, 4. Alternatively, the features (detection criteria) may be stored in both the memory 11 of the vehicle control apparatus 1 and the memory 21 of the electronic key 2, or in both the memory 11 of the vehicle control apparatus 1 and the memory 31, 41 of the smartphone 3, 4.

Although a setting completion notification is transmitted and received using an LF signal at steps S106 and S203 of FIG. 5, the setting completion notification may be transmitted and received using a UHF signal. In addition, although a setting completion notification is transmitted and received using a UHF signal at steps S106a and S308a of FIG. 11, the setting completion notification may be transmitted and received using an LF signal.

Although the first and second embodiments show the smartphones 3 and 4 as an example of a portable device, instead of a smartphone, for example, other mobile phones or portable tablets may be used as a portable device.

Although the third embodiment shows an example in which instead of operations performed on screens, operations are performed using the operating buttons or LED lamps of the electronic key 5, the display 55 of the electronic key may be composed of a liquid crystal panel so that operations on screens such as those performed on a smartphone can be performed.

Although the setting completion notification screen 33e of FIG. 6E only displays the setting completion message Me, in addition to this, the contents of set features (detection criteria) may be displayed.

Although the above-described embodiments show, as an example, the case of opening and closing the sliding door SD by a kick movement, the disclosure can also be applied to the case of opening and closing a rear door by a kick movement. In this case, the kick sensor 17 is provided underneath the rear door. In addition, a door which is an opening/closing target is not limited to a sliding door or a rear door, and may be, for example, a door that opens and closes a trunk.

Although the above-described embodiments show, as an example, a kick movement where the user kicks out his/her leg in the manner shown in FIG. 2, other movements may be performed. For example, a movement may be performed where the user moves his/her leg straight out to the front and brings it into the detection range R of the kick sensor 17 and then moves it away from the detection range R.

Although the above-described embodiments show a leg movement as an example of a user's gesture, the user's gesture is not limited to a leg movement. For example, a hand or arm movement may be detected as a gesture.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle control system comprising:
a vehicle control apparatus mounted on a vehicle; and
a portable device carried by a user,
wherein the vehicle control apparatus includes:
a door driving unit configured to open and close a door of the vehicle;
a detector configured to detect a gesture of the user; and
a controller configured to determine, based on a detection signal,
whether a predetermined gesture is performed, and allow the door driving unit to open or close the door when the predetermined gesture is performed, the detection signal being outputted from the detector,
wherein the portable device includes:
a first portable device configured to perform communication with the vehicle control apparatus; and
a second portable device configured to perform communication with the first portable device,
wherein the second portable device transmits, based on a fact that a predetermined operation by the user is performed, a notification signal to the first portable device, the notification signal notifying about the predetermined operation,
wherein when the first portable device receives the notification signal from the second portable device, the first portable device transmits the notification signal together with an identification code of the first portable device to the vehicle control apparatus,
wherein when the vehicle control apparatus detects, by the detector, a gesture of the user after receiving the notification signal and the Identification code from the first portable device, the vehicle control apparatus extracts a feature of the gesture from a detection signal for the gesture, and stores the feature so as to be associated with the identification code, and
wherein the controller determines whether the predetermined gesture is performed, based on a result of a comparison between a feature extracted from a detection signal for a subsequent gesture and the stored feature.

2. The vehicle control system according to claim 1,
wherein the first portable device is an electronic key for locking or unlocking the door of the vehicle, and
wherein the second portable device is a smartphone that performs near-field wireless communication with the first portable device.

3. A vehicle control system comprising:
a vehicle control apparatus mounted on a vehicle; and
a portable device carried by a user,
wherein the vehicle control apparatus includes:
a door driving unit configured to open and close a door of the vehicle;
a detector configured to detect a gesture of the user; and
a controller configured to determine, based on a detection signal,
whether a predetermined gesture is performed, and allow the door driving unit to open or close the door when the predetermined gesture is performed, the detection signal being outputted from the detector,
wherein the portable device transmits, based on a fact that a predetermined operation by the user is performed, a notification signal together with an identification code of the portable device to the vehicle control apparatus, the notification signal notifying about the predetermined operation,
wherein when the vehicle control apparatus detects, by the detector, a gesture of the user after receiving the notification signal and the identification code from the portable device, the vehicle control apparatus extracts a feature of the gesture from a detection signal for the gesture, and stores the feature so as to be associated with the identification code, and
wherein the controller determines whether the predetermined gesture is performed, based on a result of a comparison between a feature extracted from a detection signal for a subsequent gesture and the stored feature.

4. The vehicle control system according to claim 3,
wherein the portable device is a smartphone.

5. The vehicle control system according to claim 3,
wherein the portable device is an electronic key for locking or unlocking the door of the vehicle.

6. The vehicle control system according to claim 1,
wherein the feature of the gesture includes at least one of a peak value of the detection signal, time taken for the detection signal to reach the peak value, and a change rate at a rise of the detection signal.

7. The vehicle control system according to claim 6,
wherein the feature of the gesture includes a peak value of the detection signal, and
wherein a predetermined threshold is set for the peak value.

8. The vehicle control system according to claim 3,
wherein the feature of the gesture includes at least one of a peak value of the detection signal, time taken for the detection signal to reach the peak value, and a change rate at a rise of the detection signal.

9. The vehicle control system according to claim 8,
wherein the feature of the gesture includes a peak value of the detection signal, and
wherein a predetermined threshold is set for the peak value.
